(19) United States
(12) Patent Application Publication
(10) Pub. No.: US 2026/0361685 A1
(43) Pub. Date: Nov. 12, 2026

(54) Efficient Addressing and Commissioning of IO Modules

(71) Applicant: Siemens Schweiz AG, Zürich (CH)

(72) Inventors: Oskar Camenzind, Zug (CH); Beat Kyburz, Ottenbach (CH)

(73) Assignee: Siemens Schweiz AG, Zürich (CH)

(21) Appl. No.: 19/472,662

(22) PCT Filed: Jun. 23, 2023
(86) PCT No.: PCT/EP2023/067110

§ 371 Date: Oct. 4, 2025

(30) Foreign Application Priority Data
Apr. 4, 2023 (EP) 23166565.4

(51) Int. Cl. H04L 61/5038; H04L 41/12

(52) U.S. Cl. CPC H04L 61/5038; H04L 41/12

(57) ABSTRACT

Various embodiments of the teachings herein include a method for addressing and commissioning of I/O-Modules in a Building Automation System. The I/O-Modules are connected by a Single Pair Ethernet datalink. An example includes: discovering I/O-Modules on the I/O-Bus via node discovery and registration procedure using a Building Automation Controller of the Building Automation System; initiating a position measurement with each discovered I/O-Module on the same I/O-Bus line using the Building Automation Controller; and assigning consecutive I/O-Module-Addresses to the respective I/O-Modules using the Building Automation Controller based on the measured position of the respective I/O-Module.

### CROSS-REFERENCE TO RELATED APPLICATIONS

This application is a U.S. National Stage Application of International Application No. PCT/EP2023/067110 filed Jun. 23, 2023, which designates the United States of America, and claims priority to EP Application No. 23166565.4 filed Apr. 4, 2023, the contents of which are hereby incorporated by reference in their entirety.

### TECHNICAL FIELD

The present disclosure relates to Input-Output Modules. Various embodiments include systems and/or methods for addressing and commissioning of I/O-Modules of a Building Automation System connected by a Single Pair Ethernet (SPE) datalink.

### BACKGROUND

I/O-Modules (input/output modules or I/O module devices) are devices interfacing with the physical world and used to integrate peripheral devices such as sensors and actuators into a Building Automation System. Multiple I/O-Modules can be connected to one Building Automation Controller via an I/O-Bus. Each I/O Module needs an unambiguous I/O-Module-Address which is used by the Building Automation Controller to address the I/O-Module via the I/O-Bus.

So far, the I/O-Module-Address has been configured by the installer via a pluggable address key. This addressing method is costly since an electromechanical address decoder was required per I/O-Module, and the installer had to bring along the right set of pluggable address keys. Spare address keys from the set are thrown away (waste).

### Known Alternative Solutions:

The I/O-Module-Address can be configured via a commissioning tool, e.g., Mobile Phone and Mobile App. This procedure requires a connection such as Bluetooth, NFC, or USB between the I/O-Module and the commissioning tool. This solution requires extra hardware and makes the I/O-Module more expensive.
The I/O-Module assignment can be based on pre-engineered serial number information, e.g. printed on the I/O-Module (e.g. QR-Code). The serial number can be collected during I/O-Module installation and transferred together which the recorded Module position to the engineering tool. This solution requires extra work for the installer.
The I/O-Module-Address is automatically generated and stored in the terminal base of the I/O-Module. The electronics and firmware of the terminal base of the 1st I/O-Module, which is connected to the controller, starts automatically with I/O-Module-Address 1. The next I/O-Module in the row reads the I/O-Module-Address from the previous I/O-Module and internally adds 1 to get its address from 2 to N, etc.
Discovered I/O-Modules could be manually assigned to the engineered logical I/O-Module via a commissioning tool by selecting the engineered I/O-Module via the commissioning tool and, e.g., pushing a button on the physical I/O-Module. Pushing a button on the I/O-Module will trigger a specific identification message to initiate the assignment of the physical I/O-Module to the engineered I/O-Module if the I/O-Module-Type matches. Afterward, the controller configures the I/O-Module-Address of the selected physical I/O-Module with a specific service. This solution requires a commissioning tool and extra user interaction by the commissioning engineer. In the case of I/O-Modules in a remote cabinet, even 2 persons may be required to do the job: one at the controller to operate the commissioning tool and one person at the I/O-Module to push the button.

These solutions are time-consuming and expensive.

### SUMMARY

The teachings of the present disclosure provide more efficient mechanisms for addressing and commissioning of I/O-Modules, for example, in the field of building automation. For example, some embodiments include a method for addressing and commissioning of I/O-Modules of devices or I/O-Module-devices of a Building Automation System, wherein the I/O-Modules of devices or I/O-Module-devices being connected by a Single Pair Ethernet datalink, the method comprising: (S1) discovering I/O-Modules on the I/O-Bus via node discovery and registration procedure by a Building Automation Controller of the Building Automation System; (S2) initiating a position measurement with each discovered I/O-Module on the same I/O-Bus line by the Building Automation Controller; and (S3) assigning consecutive I/O-Module-Addresses to the respective I/O-Modules by the Building Automation Controller according to the measured position of the respective I/O-Module.

As another example, some embodiments include an arrangement for addressing and commissioning I/O-Modules of devices or I/O-Module-devices of a Building Automation System, wherein the I/O-Modules of devices or I/O-Module-devices being connected by a Single Pair Ethernet datalink, wherein a Building Automation Controller is configured to discover I/O-Modules on the I/O-Bus via node discovery and registration procedures; wherein the Building Automation Controller is configured to initiate a position measurement with each discovered I/O-Module on the same I/O-Bus line; and wherein the Building Automation Controller is configured to assign consecutive I/O-Module-Addresses to the respective I/O-Modules according to the measured position of the respective I/O-Module or according to the respective measured distance of the respective I/O-Module to the Controller.

### BRIEF DESCRIPTION OF THE DRAWINGS

The above-mentioned and other concepts of the present invention will now be addressed with reference to the drawings of the preferred embodiments of the present invention. The embodiments shown are intended to illustrate, but not to limit the scope of the disclosure. The drawings contain the following figures, in which like numbers refer to like parts throughout the description and drawings and wherein:

FIG. 1 illustrates an example arrangement for addressing and commissioning of I/O-Modules for an exemplary I/O subsystem topology incorporating teachings of the present disclosure;

FIG. 2 illustrates exemplary controller lists of engineered and discovered I/O-Modules before position measurement incorporating teachings of the present disclosure;

FIG. 3 illustrates exemplary controller lists of engineered and discovered I/O-Modules after position measurement and assignment incorporating teachings of the present disclosure; and

FIG. 4 illustrates an exemplary flowchart of a method for addressing and commissioning of I/O-Modules of devices or I/O-Module-devices of a Building Automation System connected by a Single Pair Ethernet (SPE) datalink incorporating teachings of the present disclosure.

### DETAILED DESCRIPTION

I/O module stands for Input/Output module, which is a device (I/O module device) that acts as the interface bridge between a computer system such as a Building Automation Controller at one end and an I/O device or peripheral device, such as a printer, webcam, scanner, actuator, sensor, controller, gateway, edge device, etc. Exemplary functions of an I/O module or I/O-module-device include: sensing, actuating, controlling, timing, processor communication, device communication, data buffering, error correction, error reporting.

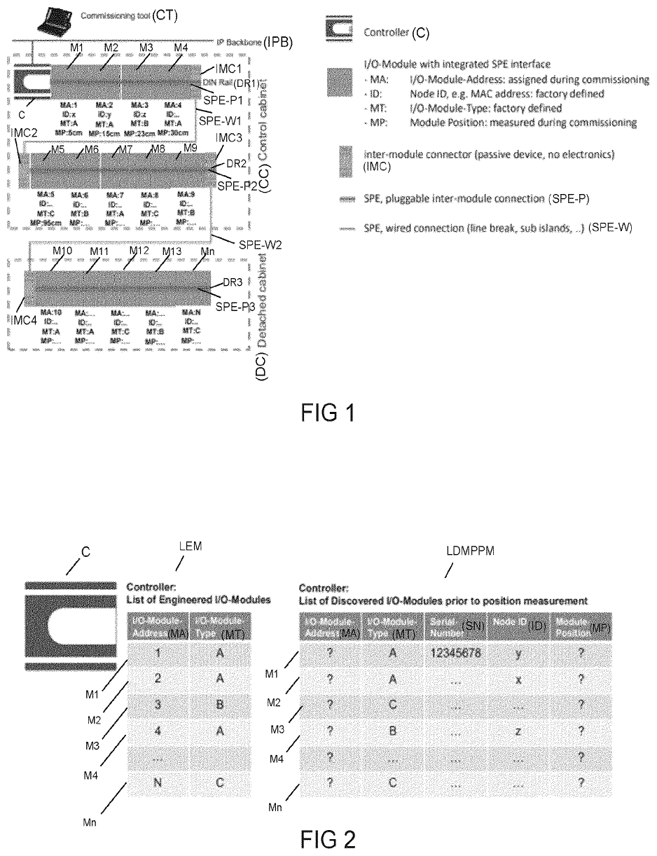

FIG. 1 illustrates an example arrangement for addressing and commissioning of I/O-Modules M1-Mn of devices or I/O-Module-devices of a Building Automation System incorporating teachings of the present disclosure, wherein the I/O-Modules M1-Mn of devices or I/O-Module-devices being connected by a Single Pair Ethernet SPE-P1-SPE-P3, SPE-W1, SPE-W2 datalink,
wherein a Building Automation Controller C is configured to discover I/O-Modules M1-Mn on the I/O-Bus via node discovery and registration procedures;
wherein the Building Automation Controller C is configured to initiate a position measurement with each discovered I/O-Module on the same I/O-Bus line;
wherein the Building Automation Controller C is further configured to assign consecutive I/O-Module-Addresses MA:1-MA:N to the respective I/O-Modules M1-Mn according to the measured position of the respective I/O-Module M1-Mn or according to the respective measured distance of the respective I/O-Module M1-Mn to the Controller C.

The arrangement according to FIG. 1 illustrates an exemplary arrangement for addressing and commissioning of I/O-Modules M1-Mn for an exemplary I/O subsystem topology incorporating teachings of the present disclosure.

The Controller C comprises suitable processing means, memory means, and interfaces to be connected to the I/O-Modules M1-Mn and to an IP backbone network IPB. The IP backbone network IPB is configured to connect different LANs or subnetworks in the same building, in different buildings, or in a campus environment.

In some embodiments, a suitable commissioning tool CT is connected to the IP backbone network IPB to communicate to the Controller C.

An I/O-Module M1-Mn comprises:
A respective I/O-Module-Address MA, MA:1-MA:N, which is assigned during commissioning.
A respective node ID, e.g. MAC address, which is factory defined.
A respective I/O-Module Type, which is factory defined.
A respective Module Position, which is determined or measured during commissioning.

Typically, the I/O-Modules M1-Mn are mounted side by side in a consecutive sequence on one or more DIN-Rails DR in a control cabinet. Within a DIN-Rail DR the I/O-Modules M1-Mn are connected by means of a pluggable inter-module connection SPE-P1-SPE-P3 for Single Pair Ethernet SPE.

By means of suitable inter-module connectors IMC, IMC1-IMC4 the I/O-Modules M1-Mn of different DIN-Rails DR are connected. The inter-module connectors IMC, IMC1-IMC4 provide the connection of a SPE pluggable inter-module connection to a SPE wired connection SPE-W1, SPE-W2, e.g. in case of line breaks, sub islands.

In some embodiments, the inter-module connectors IMC, IMC1-IMC4 are plug-in connectors, typically passive devices with no electronics.

In the exemplary illustration according to FIG. 1 the exemplary control cabinet CC comprises two DIN rails D1, D2. DIN rail D1 comprises the I/O-Modules M1-M4, DIN rail D2 comprises the I/O-Modules M5-M9. The exemplary detached cabinet DC comprises the DIN rail D3 with the I/O-Modules M10-Mn. DIN rail D1 and DIN rail D2 are interconnected by SPE wired connection SPE-W1 by means of inter-module connectors IMC1 and IMC2. DIN rail D2 and DIN rail D3 are interconnected by SPE wired connection SPE-W2 by means of inter-module connectors IMC3 and IMC4.

The Single Pair Ethernet (SPE) datalink can be a multidrop network or a multidrop I/O-Bus. The multidrop network or the multidrop I/O-Bus can be specified according to IEEE Standard 10BASE-T1S. 10BASE-T1S Single Pair Ethernet (SPE) PHY devices and MAC-PHY devices can communicate via the multidrop network or via the multidrop I/O-Bus.

10BASE-T1S is a fully standardized Ethernet PHY (Physical-Layer-Transceiver respectively physical transmission layer for sending and receiving protocols based on the OSI model), that can connect a 802.3 Clause 4-compliant MAC to a single balanced pair of conductors at the speed of 10 Mbit/s (at MAC/PLS).

“PHY” is an abbreviation for “physical layer”, it is an electronic circuit, usually implemented as an integrated circuit, required to implement physical layer functions of the OSI model in a network interface controller. A PHY connects a link layer device (also known as “MAC” as an acronym for medium access control) to a physical medium such as an optical fiber or copper cable.

The Single Pair Ethernet (SPE) datalink can be a daisy-chain network or a daisy-chain I/O-Bus. The daisy-chain network or a daisy-chain I/O-Bus can be specified according to IEEE Standard 10BASE-T1L.

10BASE-T1S and 10BASE-T1L are standardized in IEEE Std 802.3cg-2019, they are variants of 10 megabit per second Ethernet over single twisted pair. 10BASE-T1S originated in the automotive industry and is especially useful short-distance applications where substantial electrical noise can occur. 10BASE-T1L is useful especially for long-distance Ethernet, supporting connections up to 1 km in length. 10BASE-T1S and 10BASE-T1L are useful to implement applications in Internet of things environments.

In some embodiments, the I/O-Modules M1-Mn are visualized on the Controller C and/or in a tool, e.g. a commissioning tool CT with its position on a DIN Rail DR1-DR3 and/or with the I/O-Module-Type MT,MT:A,MT:B,MT:C and/or I/O-Module-Address MA, MA:1-MA:N by suitable output means, e.g. monitor connected to the tool or display of the tool. For example, in a Building Automation System a Building Automation Controller C communicates via I/O-Bus with I/O-Modules M1-Mn to read and command physical I/Os. Therefore, advantageously only one Building Automation Controller C is allowed per I/O Bus and I/O-Subsystem.

The association between an I/O-Module M1-Mn and the Building Automation Controller C is unambiguous and given by the I/O-Bus. I/O-Modules are mounted side by side in a consecutive sequence on one or more DIN-Rails DR1-DR3 in a control cabinet CC. I/O-Modules M1-Mn are characterized and identified by an I/O-Module-Type MT, MT:A, MT:B, MT:C and a logical I/O-Module-Address MA, MA:1-MA:N. For practical reasons, the I/O-Module-Address MA, MA:1-MA:N is typically the I/O-Module position number MP on the DIN Rail D1-D3. I.e., the I/O-Module closest to the Building Automation Controller C has I/O-Module-Address 1, and the last I/O-Module in the I/O-Subsystem has I/O-Module-Address N. In the Engineering System, each I/O-Module M1-Mn is characterized by its engineered I/O-Module-Type MT:A, MT:B, MT:C and the engineered logical I/O-Module-Address MA:1-MA:N. During the installation of the I/O-Modules M1-Mn, the installer must configure the correct logical I/O-Module-Address MA:1-MA:N per I/O-Module M1-Mn.

During the commissioning of the Building Automation Controller C, the firmware of the controller C will discover all I/O-Modules M1-Mn on the I/O-Bus and assign each discovered physical I/O-Module to the corresponding engineered logical representation of the I/O-Module M1-Mn if both I/O-Module-Type MT:A,MT:B,MT:C and I/O-Module-Address MA:1-MA:N match.

The assignment can be fully automatic even without I/O-Module-Address if only one instance of an I/O-Module-Type is engineered per controller C and discovered on the I/O-Bus. However, if multiple instances of the same I/O-Module-Type are discovered on the I/O-Bus, the I/O-Module-Address is needed to make the assignment. Therefore, a proper I/O-Module-Address configuration is essential to set up the I/O-Subsystem.

Single Pair Ethernet (SPE) is another set of IEEE 802.3 physical media standards to communicate Ethernet messages over a twisted pair cable. IEEE 802.3cg, for example, defines the 10BASE-T1S technology with a 10 Mbps multidrop transmission medium and 10BASE-T1L with a 10 Mbps daisy-chain link. And just like wired and wireless Ethernet networks, there is an Ethernet MAC and PHY (Datalink) for each SPE standard.

The following SPE technologies are typical:
Multidrop communication: all nodes are connected to the same bus cable.
Daisy-chain topology: each node contains two PHYs and an Ethernet switch.

### Multidrop Datalink

SPE datalinks for a multidrop network, such as 10BASE-T1S, provide topology discovery and node position detection features. These features can automatically determine the position of an I/O-Module M1-Mn on an I/O-Bus. Therefore, it is possible to configure the I/O-Module-Address automatically based on the topology discovery and communication node position detection. The Controller can initiate the discovery and position detection procedure, and the results are available either on the Controller C or on the I/O Modules M1-Mn from where the Controller C can read those values for further processing.

Procedure with a Multidrop I/O-Bus (e.g., 10BASE-T1S):
A) The Building Automation Controller C discovers I/O-Modules M1-Mn on the I/O-Bus via node discovery and registration procedure. After the discovery, a list of I/O-Modules with their node ID (e.g., PHY-ID or MAC-Address) is known. At this point, the Building Automation Controller knows the I/O-Modules on the I/O-Bus but not the position.
B) The Building Automation Controller initiates a position measurement with each discovered I/O-Module on the same I/O-Bus line. The PHY of the Building Automation Controller C will send a specific signal to the PHY of the I/O-Module, which is addressed by the node ID to trigger the position measurement between the Controller C and the I/O-Module M1-Mn. Afterward, the measured propagation delay can be queried from the PHY of the I/O-Module M1-Mn via the node ID. The propagation delay can be mapped to a cable distance on the I/O-Bus (10BASE-T1S network). Even if the measured position has only an accuracy of <a few cm (<width of physical I/O-Module), it is possible to determine the sequence of the I/O-Modules on an I/O-Bus. For instance, if the measured position has an exemplary accuracy of <5 cm it is possible to determine the sequence of the I/O-Modules on an I/O-Bus.
C) The Building Automation Controller C assigns a consecutive I/O-Module-Address MA:1-MA:N to the I/O-Modules M1-Mn according to the measured distances, starting with I/O-Module-Address 1 for the I/O-Module which is closest to the Building Automation Controller C.
D) The I/O-Modules M1-Mn can be visualized on the Controller or in a tool with its position on the DIN Rail and with the I/O-Module-Type MT:A,MT:B,MT:C or I/O-Module-Address MA:1-MA:N etc.

### Daisy-Chain Datalink

SPE Datalinks for a daisy-chain network, such as 10BASE-T1L, provide features like discovering neighbor nodes. The Controller C can initiate the neighbor discovery procedure, and the results are available on the I/O Modules M1-Mn from where the Controller can read those values for further processing.

Procedure with a Daisy-Chain I/O-Bus (e.g., 10BASE-T1L):
A) The Building Automation Controller C discovers all I/O-Modules M1-Mn on the I/O-Bus via specific discovery procedures. After the discovery, a list of I/O-Modules with their node ID (e.g., PHY-ID or MAC address) is known.
B) The Building Automation Controller C initiates a daisy-chain topology discovery for the entire I/O-Bus. Each node can detect the node ID of the two neighboring nodes (one on the left and one on the right side) in the daisy chain topology. In addition, the PHYs of each node can detect the cable length between nodes. With this information, the Building Automation Controller C can determine the entire network topology and cable distances between nodes.
C) The Building Automation Controller C assigns a consecutive I/O-Module-Address MA:1-MA:N to the I/O-Modules according to the detected I/O-Module position in the daisy-chain topology, starting with I/O-Module-Address 1 for the I/O-Module which is closest to the Building Automation Controller.
D) The I/O-Modules M1-Mn can be visualized on the Controller or in a tool with its position on the DIN Rail DR1-DR3 and with the I/O-Module-Type MT:A,MT:B,MT:C or I/O-Module-Address MA:1-MA:N etc.

FIG. 1 illustrates an arrangement for addressing and commissioning of I/O-Modules of a Building Automation System connected by a Single Pair Ethernet (SPE) datalink (e.g., Multidrop Datalink or Daisy-chain Datalink), the Building Automation System comprising one or more controllers. If the Building Automation System comprising a plurality of controllers a topology discovery of the network is required.

FIG. 2 illustrates exemplary lists of engineered I/O-Modules (LEM) and of discovered I/O-Modules prior to position measurement (LDMPPM). The lists LEM, LDMPPM are generated and hosted by the controller C. In FIG. 2 the exemplary lists LEM, LDMPPM are represented as tables. The table LEM comprises two columns with the headers I/O-Module-Address (MA) and I/O-Module-Type (MT). The lines below the headers represent exemplary I/O-Modules M1-Mn. The table LDMPPM comprises five columns with the headers I/O-Module-Address (MA), I/O-Module-Type (MT), Serial-Number (SN), Node ID (ID), and Module-Position (MP). The lines below the headers represent exemplary I/O-Modules M1-Mn.

In case the Single Pair Ethernet (SPE) datalink is a multidrop network or a multidrop I/O-Bus, for instance according to IEEE Standard 10BASE-T1S the Building Automation Controller C discovers I/O-Modules M1-Mn on the I/O-Bus via node discovery and registration procedure. After the discovery is completed a list of I/O-Modules M1-Mn with their node ID (e.g., PHY-ID or MAC Address) is known. At this point, the Building Automation Controller C knows the I/O-Modules M1-Mn on the I/O-Bus but not the position of the respective I/O-Modules M1-Mn.

In case the Single Pair Ethernet (SPE) datalink is a daisy-chain I/O-Bus, for instance according to IEEE Standard 10BASE-T1L the Building Automation Controller C discovers all I/O-Modules M1-Mn on the I/O-Bus via specific discovery procedures. After the discovery is completed a list of I/O-Modules M1-Mn with their node ID (e.g., PHY-ID or MAC address) is known, but not the position of the respective I/O-Modules M1-Mn.

In FIG. 2 the list (table) LEM illustrates the list of engineered exemplary I/O-Modules M1-Mn and the list (table) LDMPPM illustrates the list of discovered exemplary I/O-Modules M1-Mn prior to position measurement.

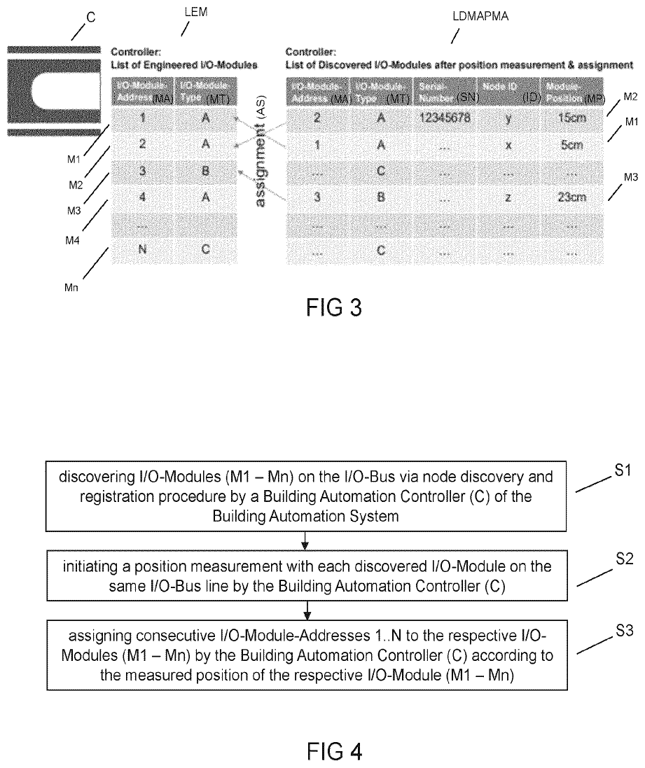

FIG. 3 illustrates exemplary lists of engineered I/O-Modules (LEM) and of discovered I/O-Modules after position measurement and assignment (LDMAPMA). The lists LEM, LDMAPMA are generated and hosted by the controller C. In FIG. 3 the exemplary lists LEM, LDMAPMA are represented as tables. The table LEM comprises two columns with the headers I/O-Module-Address (MA) and I/O-Module-Type (MT). The lines below the headers represent exemplary I/O-Modules M1-Mn. The table LDMAPMA comprises five columns with the headers I/O-Module-Address (MA), I/O-Module-Type (MT), Serial-Number (SN), Node ID (ID), and Module-Position (MP). The lines below the headers represent exemplary I/O-Modules M1-Mn.

In case the Single Pair Ethernet (SPE) datalink is a multidrop network or a multidrop I/O-Bus, for instance according to IEEE Standard 10BASE-T1S the Building Automation Controller C initiates a position measurement with each discovered I/O-Module M1-Mn on the same I/O-Bus line. The PHY (Physical-Layer-Transceiver) of the Building Automation Controller C will send a specific signal to the PHY of the respective I/O-Module M1-Mn which is addressed by the respective node ID to trigger the position measurement between the Controller C and the I/O-Module M1-Mn. Afterward, the measured propagation delay can be queried from the PHY of the I/O-Module via the node ID. The propagation delay can be mapped to a cable distance on the I/O-Bus (e.g. 10BASE-T1S network). Even if the measured position has only an accuracy of <5 cm it is possible to determine the sequence of the I/O-Modules M1-Mn on an I/O-Bus. The Building Automation Controller C is configured to assign AS a consecutive I/O-Module-Address MA:1-MA:N to the I/O-Modules M1-Mn according to the measured distances, starting with I/O-Module-Address 1 for the I/O-Module M1-Mn which is closest to the Building Automation Controller C.

In case the Single Pair Ethernet (SPE) datalink is a daisy-chain I/O-Bus, for instance according to IEEE Standard 10BASE-T1L the Building Automation Controller C initiates a daisy-chain topology discovery for the entire I/O-Bus. Each node can detect the node ID of the two neighboring nodes (one on the left and one on the right side) in the daisy chain topology. In addition, the PHYs of each node can detect the cable length between nodes. With this information, it is possible to determine the entire network topology and cable distances between nodes by the Building Automation Controller C. The Building Automation Controller is configured to assign AS a consecutive I/O-Module-Address MA:1-MA:N to the I/O-Modules M1-Mn according to the detected I/O-Module position in the daisy-chain topology, starting with I/O-Module-Address 1 for the I/O-Module which is closest to the Building Automation Controller C.

In FIG. 3 the list LEM illustrates the list of engineered I/O-Modules M1-Mn and the list LDMAPMA illustrates the list of discovered I/O-Modules M1-Mn after position measurement and assignment AS. The arrows indicate the respective assignment AS.

FIG. 4 illustrates an exemplary flowchart of a method for addressing and commissioning of I/O-Modules of devices or I/O-Module-devices of a Building Automation System connected by a Single Pair Ethernet (SPE) datalink, the method comprising:
(S1) discovering I/O-Modules (M1-Mn) on the I/O-Bus via node discovery and registration procedure by a Building Automation Controller (C) of the Building Automation System;
(S2) initiating a position measurement with each discovered I/O-Module on the same I/O-Bus line by the Building Automation Controller (C);
(S3) assigning consecutive I/O-Module-Addresses (MA:1-MA:N) to the respective I/O-Modules (M1-Mn) by the Building Automation Controller (C) according to the measured position of the respective I/O-Module (M1-Mn).

In some embodiments, assigning consecutive I/O-Module-Addresses MA:1-MA:N to the respective I/O-Modules (M1-Mn) is according the respective measured distance of the respective I/O-Module (M1-Mn) to the Controller (C).

The controller and the Building Automation System comprising suitable processing means, storing means, communication means, I/O means to perform the method steps for addressing and commissioning of I/O-Modules of devices or I/O-Module-devices of a Building Automation System connected by a Single Pair Ethernet (SPE) datalink.

### Scenario: Multidrop Network, or a Multidrop I/O-Bus, Especially According to IEEE Standard 10BASE-T1S

In case the Single Pair Ethernet (SPE-P1-SPE-P3, SPE-W1, SPE-W2) datalink is a multidrop network, or a multidrop I/O-Bus, especially according to 10BASE-T1S, advantageously the discovering of I/O-Modules (M1-Mn) is performed based on the topology discovery and/or communication node position detection.

In some embodiments, to measure the position measurement of the I/O-Modules (M1-Mn), the physical interface PHY of the Building Automation Controller (C) sends a specific signal to the physical interface PHY of the I/O-Module (M1-Mn) which is addressed by the node ID to trigger the position measurement between the Building Automation Controller (C) and the respective I/O-Module (M1-Mn),
wherein a measured propagation delay is queried from the physical interface PHY of the I/O-Module (M1-Mn) via the node ID,
wherein the propagation delay is mapped to a cable distance on the I/O-Bus, especially 10BASE-T1S network.

In some embodiments, to determine the sequence of the I/O-Modules (M1-Mn) on an I/O-Bus the measured position has an accuracy of <5 cm.

In some embodiments, to determine the sequence of the I/O-Modules (M1-Mn) on an I/O-Bus the accuracy of the position measurement or the distance measurement is <4 of the width of an I/O-Module (M1-Mn). This increases the quality of the position measurement or the distance measurement. Applying findings of the Nyquist-Shannon sampling theorem.

In some embodiments, to determine the sequence of the I/O-Modules (M1-Mn) on an I/O-Bus the measured position has as accuracy the width, especially the physical width, of an I/O-Module (M1-Mn).

In some embodiments, the controller (C) is located at one of the ends of the bus line, in case the Building Automation System comprising one controller.

In some embodiments, in case the Building Automation System comprising one controller (C) and said controller (C) is not located at one of the ends of the bus line, a suitable topology discovery is performed in addition to the position measurement.

In some embodiments, in case the Building Automation System comprising a plurality of controllers (C) a suitable topology discovery is performed in addition to the position measurement.

In some embodiments, the network or the I/O-Bus comprises an coordinator. The coordinator can be on the automation station (e.g. building management station) or on an I/O-Module that is part of the local bus line (e.g. as branch connection module). The controller then triggers the distance measurement on the coordinator and an I/O module of the same bus line or the same bus section. The coordinator can be implemented or integrated in the automation station or on a branch connection module. A detached cabinet and a branch connection module can be connected via LAN. An automation station is configured to find the respective coordinator of the respective bus line.

### Scenario: Daisy-Chain Network or a Daisy-Chain I/O-Bus, Especially According to IEEE Standard 10BASE-T1L

In case the Single Pair Ethernet (SPE-P1-SPE-P3, SPE-W1, SPE-W2) datalink is a daisy-chain network or a daisy-chain I/O-Bus, especially according to 10BASE-T1L, the discovering of the I/O-Modules (M1-Mn) on the I/O-Bus is performed by suitable discovery procedures for daisy-chain networks, initiated by the Building Automation Controller (C).

In some embodiments, the Building Automation Controller (C) initiates a daisy-chain topology discovery for the entire I/O-Bus,
wherein each node detects the node ID of its two direct neighboring nodes in the daisy chain topology,
wherein the physical interfaces PHYs of each node detect the cable length between the nodes. The Building Automation Controller (C) determines based on the cable length between the nodes the entire network topology and the respective cable distances between the nodes.

In some embodiments, the I/O-Modules (M1-Mn) are visualized on the Controller (C) and/or in a tool (e.g. Commissioning Tool (CT) by suitable output means (e.g. display).

In some embodiments, the I/O-Modules (M1-Mn) are visualized on the Controller (C) and/or in a tool (CT) with its position on a DIN Rail (DR) and/or with the I/O-Module-Type (MT,MT:A,MT:B,MT:C) and/or I/O-Module-Address (MA, MA:1-MA:N) by suitable output means (e.g. display).

### Potential Advantages of Embodiments of the Teachings Herein

Costly pluggable address keys and the address decoder on the I/O-Module are no longer needed. The installer no longer needs to care about having the right address keys in place. Spare address keys are not thrown away.
The I/O-Module-Address is given by the I/O-Module position on the DIN Rail, which is also known at engineering time.
In case of wrongly placed I/O-Modules at installation time, there is no need to reinstall and rewire the I/O-Modules. The position of the physical I/O-Module can be kept, and the I/O-Module-Address of the engineered logical representation of the I/O-Module can be adapted via a commissioning tool.

Reference Signs

| | |
|---|---|
| C | Controller |
| CT | Commissioning Tool |
| CC | Control Cabinet |
| DC | Detached Cabinet |
| M1-Mn | I/O-Module |
| ID, ID: x, ID: y, ID: z | Node ID |
| MA, MA: 1-MA: N | I/O-Module Address |
| MT, MT: A, MT: B, MT: C | I/O-Module Type |
| MP | I/O-Module Position |
| IPB | IP Backbone |
| DR1-DR3 | DIN Rail |
| IMC, IMC1-IMC4 | Inter-Module Connector |
| SPE | Single Pair Ethernet |
| SPE-P, SPE-P1-SPE-P3 | SPE pluggable inter-module |
| | connection |
| SPE-W, SPE-W1, SPE-W2 | SPE wired connection |
| LEM | List of Engineered I/O-Modules |
| LDMPPM | List of Discovered I/O-Modules |
| | prior to position measurement |
| LDMAPMA | List of Discovered I/O-Modules |
| | after position measurement and |
| | assignment |
| SN | Serial Number |
| AS | Assignment |
| S1-S3 | Method Step |

What is claimed is:

1. A Method for addressing and commissioning of I/O-Modules in a Building Automation System, wherein the I/O-Modules are connected by a Single Pair Ethernet datalink, the method comprising:
discovering I/O-Modules on the I/O-Bus via node discovery and registration procedure using a Building Automation Controller of the Building Automation System;
initiating a position measurement with each discovered I/O-Module on the same I/O-Bus line using the Building Automation Controller; and
assigning consecutive I/O-Module-Addresses to the respective I/O-Modules using the Building Automation Controller based on the measured position of the respective I/O-Module.

2. The Method according to claim 1, wherein assigning consecutive I/O-Module-Addresses to the respective I/O-Modules is based on the respective measured distance between the respective I/O-Module and the Controller.

3. The Method according to claim 1, wherein:
the Single Pair Ethernet datalink comprises a multidrop network, or a multidrop I/O-Bus; and
discovering I/O-Modules is based on the topology discovery and/or communication node position detection.

4. The Method according to according to claim 1, wherein:
the Single Pair Ethernet datalink comprises a multidrop network, or a multidrop I/O-Bus;
to measure the position measurement of the I/O-Modules, the physical interface of the Building Automation Controller sends a specific signal to the physical interface PHY of the I/O-Module addressed by the node ID to trigger the position measurement between the Building Automation Controller and the respective I/O-Module;
a measured propagation delay is queried from the physical interface of the I/O-Module via the node ID; and
the propagation delay is mapped to a cable distance on the I/O-Bus.

5. The Method according to claim 4, wherein the measured position has an accuracy of <5 cm to determine the sequence of the I/O-Modules on an I/O-Bus.

6. The Method according to claim 4, wherein the accuracy of the position measurement is <½ of the width of an I/O-Module to determine the sequence of the I/O-Modules on an I/O-Bus.

7. The Method according to claim 4, wherein the measured position has as accuracy the width of an I/O-Module to determine the sequence of the I/O-Modules on an I/O-Bus.

8. The Method according to claim 1, wherein the controller is located at one of the ends of the bus line and the Building Automation System comprises only one controller.

9. The Method according to claim 1, wherein the Building Automation System comprising only one controller not located at one of the ends of the bus line, a suitable topology discovery is performed in addition to the position measurement.

10. The Method according to claim 1, wherein:
the Building Automation System comprises a plurality of controllers; and
a suitable topology discovery is performed in addition to the position measurement.

11. The Method according to claim 1, wherein:
the Single Pair Ethernet datalink comprises a daisy-chain network or a daisy-chain I/O-Bus; and
discovering the I/O-Modules on the I/O-Bus is performed by suitable discovery procedures for daisy-chain networks, initiated by the Building Automation Controller.

12. The Method according to claim 11,
wherein;
the Building Automation Controller initiates a daisy-chain topology discovery for the entire I/O-Bus;
each node detects the node ID of its two direct neighboring nodes in the daisy chain topology; and
the physical interfaces PHYs of each node detect the cable length between the nodes.

13. The Method according to claim 12,
wherein based on the cable length between the nodes the entire network topology and the respective cable distances between nodes are determined by the Building Automation Controller.

14. The Method according to claim 1, wherein the I/O-Modules are visualized on the Controller and/or in a tool by suitable output means.

15. The Method according to claim 1, wherein the I/O-Modules are visualized on the Controller and/or in a tool with a position on a DIN Rail and/or with the I/O-Module-Type and/or I/O-Module-Address by suitable output means.

16. An arrangement for addressing and commissioning of I/O-Modules of devices of a Building Automation System, wherein the I/O-Modules are connected by a Single Pair Ethernet datalink, the arrangement comprising:
a Building Automation Controller to discover I/O-Modules on the I/O-Bus via node discovery and registration procedures;
wherein the Building Automation Controller initiates a position measurement with each discovered I/O-Module on the same I/O-Bus line;
wherein the Building Automation Controller assigns consecutive I/O-Module-Addresses to the respective I/O-Modules according to the measured position of the respective I/O-Module or the respective measured distance of the respective I/O-Module to the Controller.

17. The arrangement according to claim 16,
wherein the Single Pair Ethernet datalink comprises a multidrop network, or a multidrop I/O-Bus.

18. The arrangement according to claim 16, further comprising output means to visualize the I/O-Modules on the Controller and/or in a tool with a corresponding position on a DIN Rail and/or with the I/O-Module-Type and/or I/O-Module-Address.
